(19) United States
(12) Patent Application Publication
(10) Pub. No.: US 2007/0283085 A1
(43) Pub. Date: Dec. 6, 2007

(54) External hard disk carrier with a capacity status display functionality

(76) Inventor: Teng-Chang Lin, Siluo Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/496,528

(22) Filed: Aug. 1, 2006

(30) Foreign Application Priority Data
Jun. 5, 2006 (TW) 95124544

(51) Int. Cl. G06F 12/00

(52) U.S. Cl. 711/112

(57) ABSTRACT

An external hard disk carrier with a capacity status display function is described. The external hard disk carrier comprises a hard disk, a microprocessor to calculate the capacity status of the hard disk and an e-paper display apparatus or cholesteric liquid crystal display apparatus to display the capacity status of the hard disk, wherein the e-paper display apparatus or cholesteric liquid crystal display apparatus continues to display the latest capacity status after turned off.

### RELATED APPLICATIONS

The present application is based on, and claims priority from, Taiwan Application Serial Number 95124544, filed on Jul. 05, 2006, the disclosure of which is hereby incorporated by reference herein in its entirety.

### BACKGROUND

1. Field of Invention

The present invention relates to an external storage apparatus. More particularly, the present invention relates to an external hard disk carrier.

2. Description of Related Art

An external hard drive a popular external storage media. External hard drives advantages include large capacities and fast reads and writes. These advantages enable users to conveniently store desired data on external hard drives.

Users are unable to know the storage capacity status of a conventional external hard drive unless the conventional external hard drive is connected to a computer equipped with Windows operation system. This can cause inconvenience to users to some degree.

### SUMMARY

Thus, an external hard disk carrier with a capacity status display function is provided. The external hard disk carrier comprises a hard disk, a microprocessor to calculate the capacity status of the hard disk and an e-paper display apparatus or cholesteric liquid crystal display apparatus to display the capacity status of the hard disk, wherein the e-paper display apparatus or cholesteric liquid crystal display apparatus continues to display the latest capacity status after turned off.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates an external hard disk carrier according to one preferred embodiment of this invention;

FIG. 2 illustrates a block diagram of an external hard disk carrier according to one preferred embodiment of this invention;

FIG. 3 is a flowchart to calculate the capacity status of an external hard disk carrier according to one preferred embodiment of this invention; and

FIG. 4 is a flowchart to display data on an e-paper or cholesteric liquid crystal display apparatus according for one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

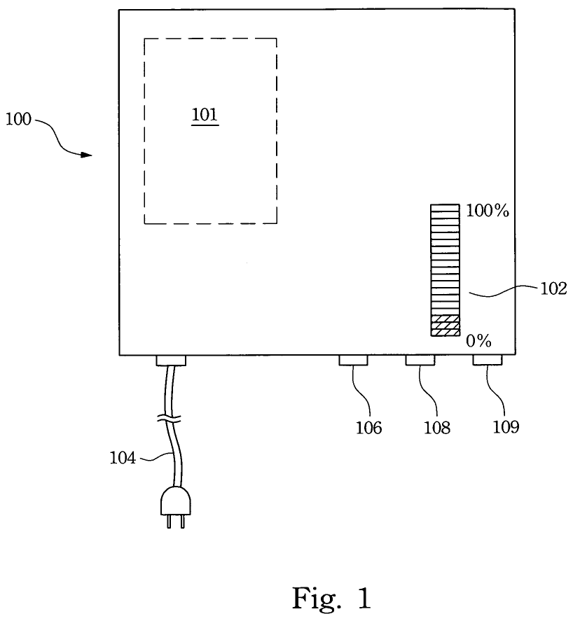

FIG. 1 illustrates an external hard disk carrier according to one preferred embodiment of this invention. This preferred embodiment is especially suitable for an external hard disk carrier 100, of which a hard disk 101 cannot be removed by a user at will. Other external storage media with easily removable storage, i.e. an optical disk or a memory card, is not suitable for the application disclosed below. An important aspect of this preferred embodiment is to use an e-paper (electronic paper) display apparatus or cholesteric liquid crystal display apparatus 102 to display the hard disk capacity status. The e-paper display apparatus or cholesteric liquid crystal display apparatus continues to display the latest capacity status after turned off. When the e-paper display apparatus or cholesteric liquid crystal display apparatus is integrated into the external hard disk carrier 100, the above-mentioned feature enables the external hard disk carrier 100 to display the latest hard disk carrier capacity status when turned off. Since the capacity status of the hard disk carrier remains unchanged when turned off, the e-paper display apparatus or cholesteric liquid crystal display apparatus displays the correct capacity status when turned off. Thus, the external hard disk carrier 100 capacity status is shown when the hard disk carrier is turned off and users can recognize the capacity status of the external hard disk carrier 100 before the external hard disk carrier 100 is turned on. A connection interface of the external hard disk carrier 100 can be a USB connector 106, an IEEE 1394 connector 108 and a SATA (Serial ATA) connector 109. When the e-paper display apparatus or cholesteric liquid crystal display apparatus 102 is applied, some number or symbol (i.e. 30%) can be labeled around the e-paper display apparatus or cholesteric liquid crystal display apparatus 102 to assist reading the capacity status.

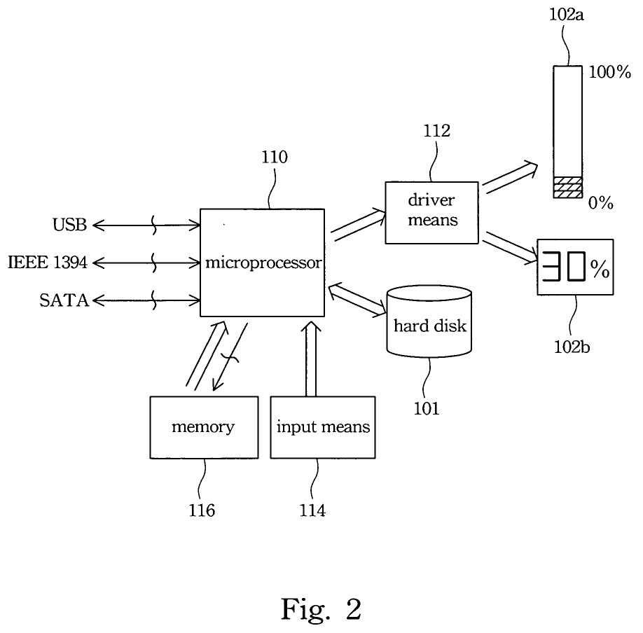

FIG. 2 illustrates a block diagram of an external hard disk carrier according to one preferred embodiment of this invention. In order to calculate a capacity status of a hard disk 101, a microprocessor 110 (coupled to the hard disk 101) is needed. The capacity status calculated by the microprocessor 110 is displayed on the e-paper display apparatus or cholesteric liquid crystal display apparatus 102 though a driver means 112, i.e. a voltage-raising circuit. The driver means 112 may have different designs according to different e-paper display apparatus or cholesteric liquid crystal display apparatus. Before a new capacity status is displayed on the e-paper display apparatus or cholesteric liquid crystal display apparatus, the e-paper display apparatus or cholesteric liquid crystal display apparatus refreshes itself to an initial status. The capacity status can be the ratio of used storage capacity to maximum storage capacity, the ratio of unused storage capacity to maximum storage capacity, the used storage capacity or the unused storage capacity. The e-paper display apparatus or cholesteric liquid crystal display apparatus can display the capacity status with a bar graph, numbers or symbols representing percentage around (illustrated as the designator 102a). Alternately, the e-paper display apparatus or cholesteric liquid crystal display apparatus can display the capacity status with numerals, i.e. 30 GB or a ratio (illustrated as the designator 102b). In some embodiments, the capacity status can be a graph to display the ratio of a used storage capacity to the maximum storage capacity, the ratio of unused storage capacity to the maximum storage capacity, the ratio of the used storage capacity to the unused storage capacity or a ratio of the unused storage capacity to the used storage capacity. The above-mentioned graph can be bar graph or other graphs, which can show a ratio. In other embodiments, the e-paper display apparatus is a segmented e-paper display apparatus, which is laminated on a flexible or rigid electrode-patterned backplane, individually addressing each segment, and an individual segment color can be directly driven and separately controlled. A memory module 116 (ex: a flash memory) can be added to store firmware to calculate the capacity status. An input means 114 can also be added to input data into the microprocessor 110.

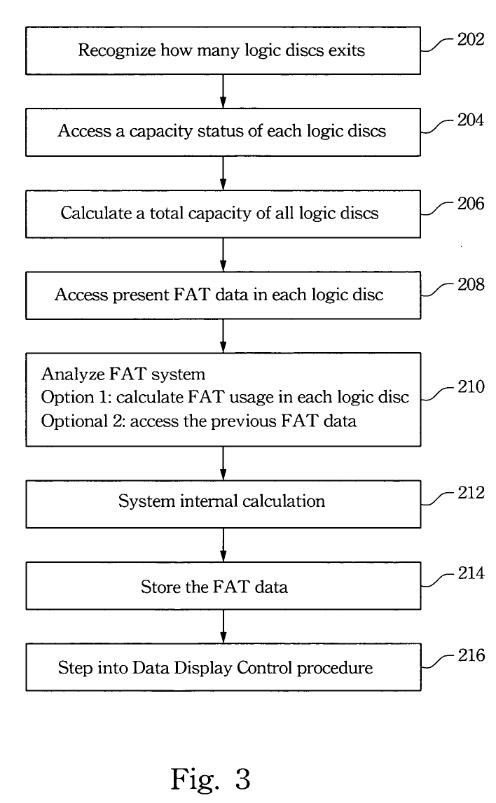

FIG. 3 is a flowchart to calculate the external hard disk carrier capacity status according to one preferred embodiment of this invention. Step 202 recognizes how many logic discs (a partition of a hard disk) exit. Step 204 accesses the capacity status of each logic discs, and step 206 calculates the total capacity of all logic discs. Step 208 accesses present FAT (file allocation table) data in each logic disc, and then step 210 analyzes the FAT data. There are two options in step 210. When the FAT data step 208 accesses is same as a previous one, option 2 is applied, i.e. FAT data stored by step 214. When the FAT data step 208 accesses is different from the previous one, option 1 is applied. In step 212, the capacity status of all logic discs is calculated. Step 214 stores the updated FAT data in a logic disc. Step 216 displays the data calculated by step 212 on the e-paper display apparatus or cholesteric liquid crystal display apparatus.

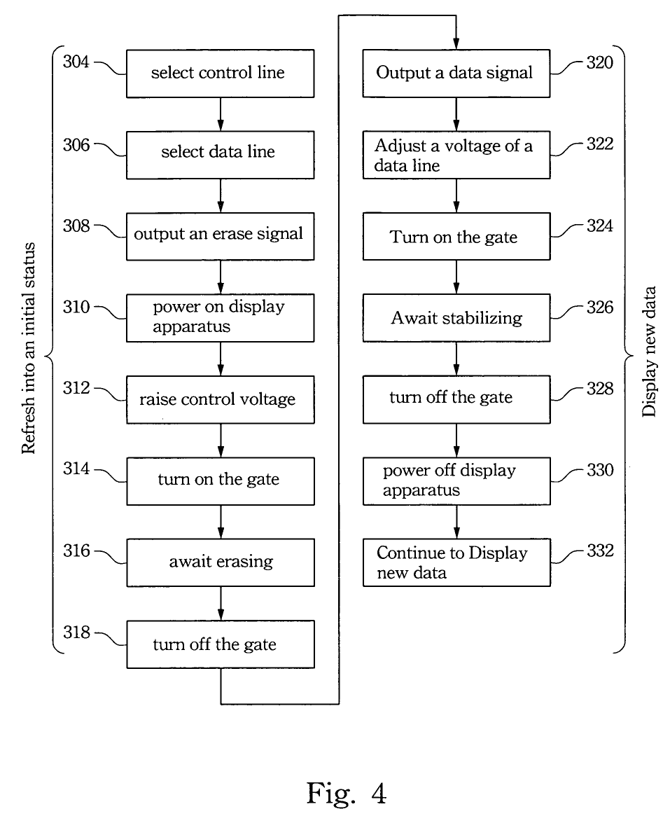

FIG. 4 is a flowchart to display data on an e-paper or cholesteric liquid crystal display apparatus according to one preferred embodiment of this invention. This flowchart displays the data obtained from the process of FIG. 3 on the e-paper display apparatus or cholesteric liquid crystal display apparatus. It is necessary for the e-paper display apparatus or cholesteric liquid crystal display apparatus to refresh into an initial status before the new capacity status is displayed. Steps 304-318 refresh the e-paper display apparatus or cholesteric liquid crystal display apparatus to an initial status. Steps 304 and 306 select the area to refresh. Step 312 raises the control voltage to refresh (or erase) a selected area to an initial status. When the gate is turned on (step 314), it takes some time to execute step 316, and step 318 ends this refreshing process.

Steps 320-332 display new data, wherein step 320 outputs the result obtained from step 212 of FIG. 3. Between turning on the gate (step 324) and turning off the gate (step 328), the result is displayed on the target area of the e-paper display apparatus or cholesteric liquid crystal display apparatus. Even after the e-paper display apparatus or cholesteric liquid crystal display apparatus turns off (step 330), the display apparatus continue to display the latest data without power.

According to preferred embodiments of the present invention, the e-paper display apparatus or cholesteric liquid crystal display apparatus without power is able to display the latest capacity status with power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An external hard disk carrier having a capacity status display functionality, the external hard disk carrier comprising:
a hard disk;
a microprocessor for calculating the capacity status of the hard disk; and
an e-paper display apparatus for displaying the capacity status of the hard disk, wherein the e-paper display apparatus continues to display the latest capacity status after turned off.

2. The external hard disk carrier of claim 1, wherein the capacity status is a ratio of a used storage capacity to a maximum storage capacity or a ratio of an unused storage capacity to the maximum storage capacity.

3. The external hard disk carrier of claim 1, wherein the capacity status is a used storage capacity.

4. The external hard disk carrier of claim 1, wherein the capacity status is an unused storage capacity.

5. The external hard disk carrier of claim 1, wherein the capacity status is a graph for displaying a ratio of a used storage capacity to a maximum storage capacity, a ratio of an unused storage capacity to the maximum storage capacity, a ratio of the used storage capacity to the unused storage capacity or a ratio of the unused storage capacity to the used storage capacity.

6. The external hard disk carrier of claim 1 further comprising a driver means respectively coupled to the microprocessor and the e-paper display apparatus.

7. The external hard disk carrier of claim 1 further comprises an input means for inputting data into the microprocessor.

8. The external hard disk carrier of claim 1 further comprises a memory module to store firmware to calculate the capacity status.

9. The external hard disk carrier of claim 1, wherein the e-paper display apparatus is a segmented e-paper display apparatus.

10. An external hard disk carrier having a capacity status display functionality, the external hard disk carrier comprising:
a hard disk;
a microprocessor for calculating the capacity status of the hard disk; and
a cholesteric liquid crystal display apparatus for displaying the capacity status of the hard disk, wherein the cholesteric liquid crystal display apparatus continues to display the latest capacity status after turned off.

11. The external hard disk carrier of claim 10, wherein the capacity status is a ratio of a used storage capacity to a maximum storage capacity or a ratio of an unused storage capacity to the maximum storage capacity.

12. The external hard disk carrier of claim 10, wherein the capacity status is the used storage capacity.

13. The external hard disk carrier of claim 10, wherein the capacity status is the unused storage capacity.

14. The external hard disk carrier of claim 10, wherein the capacity status is a graph for displaying a ratio of a used storage capacity to a maximum storage capacity, a ratio of an unused storage capacity to the maximum storage capacity, a ratio of the used storage capacity to the unused storage capacity or a ratio of the unused storage capacity to the used storage capacity.

15. The external hard disk carrier of claim 10 further comprising a driver means respectively coupled to the microprocessor and the e-paper display apparatus.

16. The external hard disk carrier of claim 10 further comprising an input means for inputting data into the microprocessor.

17. The external hard disk carrier of claim 10 further comprising a memory module to store firmware to calculate the capacity status of the hard disk carrier.
